(19) United States
(12) Patent Application Publication
(10) Pub. No.: US 2018/0111349 A1
(43) Pub. Date: Apr. 26, 2018

(54) METHOD FOR THE MANUFACTURE OF A POLYMER FOAM COMPOSITE, POLYMER FOAM COMPOSITES PREPARED THEREBY, AND ARTICLES PREPARED THEREFROM

(71) Applicant: ROGERS CORPORATION, Rogers, CT (US)

(72) Inventors: Trevor Polidore, Somerville, MA (US); Murali Sethumadhavan, Acton, MA (US); Emma Kaeli, Medway, NY (US); Sharon Soong, Natick, MA (US)

(21) Appl. No.: 15/558,711

(22) PCT Filed: Mar. 15, 2016
(86) PCT No.: PCT/US2016/022421

§ 371 Date: Sep. 15, 2017

Related U.S. Application Data
(60) Provisional application No. 62/245,548, filed on Oct. 23, 2015.
(60) Provisional application No. 62/133,546, filed on Mar. 16, 2015.

(51) Int. Cl. B32B 5/24; B32B 5/18; B32B 5/02; B32B 7/04; B29C 44/12; B32B 27/40; B32B 37/15

(52) U.S. Cl. CPC B32B 5/245; B32B 5/18; B32B 5/022; B32B 2038/0084; B29C 44/1209; B32B 27/40; B32B 37/15; B32B 7/04

(57) ABSTRACT

A method for the manufacture of a polymer foam composite includes forming a polymer foam that is at least partially uncured; contacting the formed polymer foam with a fibrous mat including a plurality of nonwoven fibers having an average diameter of 100 um or less under conditions effective to infiltrate a portion of the polymer foam into the mat, to provide a pre-composite; and curing the pre-composite to form the polymer foam composite. The pre-composite includes a polymer foam layer and an intermixed layer including the fibrous mat and the same polymer as the polymer of the polymer foam layer. The polymer foam composite includes a cured polymer foam layer and an intermixed layer integrally bonded to the first layer, wherein the intermixed layer includes the fibrous mat and a cured polymer the same as the polymer of the cured polymer foam layer.

### BACKGROUND

Polymeric foams include a plurality of voids, also called cells, dispersed in a polymer matrix. Polymer foams are of importance and have found wide usage in industry in many diverse contexts because of their ability to absorb mechanical, electrical, thermal, and acoustical energy, their low density, their particular surface characteristics of texture and non-skid and non-abrasive surfaces, and for their unusual appearance. For example, the absorption of mechanical shocks and the like is an important area for the usage of polymer foams, for example in electronic devices or the packaging of fragile materials such as eggs, electrical components, light bulbs, optical instruments, jewelry, fruits and vegetables, glassware, ceramics, and many other materials.

Conventional polymer foams, for example polyurethane foams, are typically mechanically weak when cast at small thicknesses, for example thicknesses less than 1 millimeter (mm) (about 37 mils). This is especially true for low density polymer foams. Many applications now require small thickness and low density polymer foams to meet new device designs and performance standards. It would therefore be advantageous to provide polymer foams having small thicknesses and good mechanical properties and structural integrity to meet current manufacturing needs. There accordingly remains a need in the art for thin, mechanically robust polymer foam compositions and methods of preparing such foams.

### BRIEF DESCRIPTION

A method for the manufacture of a polymer foam composite comprises forming a polymer foam that is at least partially uncured; contacting the formed polymer foam with a fibrous mat comprising a plurality of nonwoven fibers having an average diameter of 100 micrometer (um) or less, under conditions effective to infiltrate a portion of the polymer foam into the fibrous mat, to provide a pre-composite comprising a polymer foam layer, and an intermixed zone in contact with a side of the polymer foam layer, the intermixed zone comprising the fibrous mat and the same polymer as the polymer of the polymer foam layer; and curing the pre-composite to form the polymer foam composite comprising a cured polymer foam layer; and an intermixed layer integrally bonded to the cured polymer foam layer, the intermixed layer comprising, the fibrous mat and a cured polymer the same as the polymer of the cured polymer foam layer.

A polymer foam composite prepared according to the method is also described.

A polymer foam composite comprises a cured polymer foam layer, and an intermixed layer integrally bonded to the cured polymer foam layer, the intermixed layer comprising a fibrous mat comprising a plurality of fibers having an average diameter of 100 um or less, and a cured polymer that is the same as the polymer of the cured polymer foam layer.

An article comprising the above-described polymer foam composite is also disclosed.

The above described and other features are exemplified by the following Figures and Detailed Description.

### BRIEF DESCRIPTION OF THE DRAWINGS

The following Figures are exemplary embodiments, wherein like elements are numbered alike.

FIG. 1 is a schematic depiction of the process for producing the polymer foam composite of the present disclosure.

FIG. 2 shows the results of a ball drop impact test using a 4.3 gram steel ball dropped from a height of 30.5 centimeters.

### DETAILED DESCRIPTION

Described herein is a method for the manufacture of a polymer foam composite, and polymer foam composites prepared by the method. In particular, the inventors hereof have unexpectedly discovered that use of a fibrous, nonwoven mat integrated into a portion of a thin polymer foam layer provides thin polymer foam composites having improved mechanical properties, in particular compressive force deflection and impact or shock absorption, without significantly affecting compression set resistance. Therefore, the method disclosed herein can also be used to improve the mechanical properties of a polymer foam. The polymer foam composites advantageously exhibit improved mechanical properties including compressive force deflection (CFD), tensile strength, and tear strength. The polymer foam composites are particularly useful for applications requiring impact-absorbing materials or components, such as personal electronic devices.

Accordingly, an aspect of the disclosure is a method for the manufacture of the polymer foam composite. The method comprises forming a polymer foam that is at least partially uncured from a precursor composition. Polymers for use in the foams can be selected from a wide variety of foamable thermosetting compositions.

Examples of foamable thermosetting compositions that can be used include polyurethanes, epoxys, melamines, phenolics (e.g., phenol formaldehydes), urea-formaldehydes, vinyl esters, polyisocyanurate, acrylics, polyesters, polyimides, silicones, and the like, or a combination comprising at least one of the foregoing thermosetting resins. Combinations of thermosetting polymers can be used. The precursor compositions for these thermosetting foams are at least partially uncured, and in some instances, substantially or fully uncured, to facilitate foam formation.

Other additives known for use in the manufacture of foams can be present in the precursor compositions, for example other fillers, such as reinforcing fillers such as woven webs, silica, glass particles, and glass microballoons, fillers used to provide thermal management, or flame retardant fillers or additives. Suitable flame retardants include, for example, a metal hydroxide containing aluminum, magnesium, zinc, boron, calcium, nickel, cobalt, tin, molybdenum, copper, iron, titanium, or a combination thereof, for example aluminum trihydroxide, magnesium hydroxide, calcium hydroxide, iron hydroxide, and the like; a metal oxide such as antimony oxide, antimony trioxide, antimony pentoxide, iron oxide, titanium oxide, manganese oxide, magnesium oxide, zirconium oxide, zinc oxide, molybdenum oxide, cobalt oxide, bismuth oxide, chromium oxide, tin oxide, nickel oxide, copper oxide, tungsten oxide, and the like; metal borates such as zinc borate, zinc metaborate, barium metaborate, and the like; metal carbonates such as zinc carbonate, magnesium carbonate, calcium carbonate, barium carbonate, and the like; melamine cyanurate, melamine phosphate, and the like; carbon black, expandable graphite flakes (for example those available from GrafTech International, Ltd. under the tradename GRAFGUARD), and the like; nanoclays; and brominated compounds. Exemplary flame retardant materials are magnesium hydroxides, nanoclays, and brominated compounds. In some embodiments, flame retardance of the polymer foam meets certain Underwriter's Laboratories (UL) standards for flame retardance. For example, the polymer foam has a rating of V-0 under UL Standard 94.

Still other additives that can be present include dyes, pigments (for example titanium dioxide and iron oxide), antioxidants, antiozonants, ultraviolet (UV) stabilizers, conductive fillers, catalysts for cure of the polymer, crosslinking agents, and the like, as well as combinations comprising at least one of the foregoing additives.

As is known in the art, a polymer foam is generally formed from a precursor composition that is mixed prior to or concomitant with foaming. Foaming can be by mechanical frothing or blowing (using chemical or physical blowing agents, or both), or a combination of mechanical frothing and blowing (using chemical or physical blowing agents, or both). Preferably the foam is formed by mechanical frothing, which allows greater control over foam thickness and improved cell structure. Specific polymers for use in the manufacture of the foams include polyurethane foams and silicone foams.

Polyurethane foams are formed from precursor compositions comprising an organic polyisocyanate component, an active hydrogen-containing component reactive with the polyisocyanate component, a surfactant, and a catalyst. The process of forming the foam can use chemical or physical blowing agents, or the foam can be mechanically frothed. For example, one process of forming the foam comprises substantially and uniformly dispersing inert gas throughout a mixture of the above-described composition by mechanical beating of the mixture to form a heat curable froth that is substantially structurally and chemically stable, but workable at ambient conditions; and curing the froth to form a cured foam. In some embodiments, a physical blowing agent is introduced into the froth to further reduce foam density during the crosslinking process. In another embodiment, the polyurethane foam is formed from the reactive composition using only physical or chemical blowing agents, without the use of any mechanical frothing.

Suitable organic polyisocyanates include isocyanates having the general formula Q(NCO)ᵢ wherein i is an integer of two or more and Q is an organic radical having the valence of i, wherein i has an average value greater than 2. Q can be a substituted or unsubstituted hydrocarbon group that may or may not contain aromatic functionality, or a group having the formula Q¹-Z-Q¹ wherein Q¹ is a C₁₋₃₆ alkylene or C₆₋₃₆ arylene group and Z is —O—, —O-Q²-O, —CO—, —S—, —S-Q²-S—, —SO—, —SO₂—, C₁₋₂₄ alkylene or C₆₋₂₄ arylene. Examples of such polyisocyanates include hexamethylene diisocyanate, 1,8-diisocyanato-p-methane, xylyl diisocyanate, diisocyanatocyclohexane, phenylene diisocyanates, tolylene diisocyanates, including 2,4-tolylene diisocyanate, 2,6-tolylene diisocyanate, and crude tolylene diisocyanate, bis(4-isocyanatophenyl)methane, chlorophenylene diisocyanates, diphenylmethane-4,4′-diisocyanate (also known as 4,4′-diphenyl methane diisocyanate, or MDI) and adducts thereof, naphthalene-1,5-diisocyanate, triphenylmethane-4,4′,4″-triisocyanate, isopropylbenzene-alpha-4-diisocyanate, and polymeric isocyanates such as polymethylene polyphenylisocyanate.

Q can also represent a polyurethane radical having a valence of i in which case Q(NCO)ᵢ is a composition known as a prepolymer. Such prepolymers are formed by reacting a stoichiometric excess of a polyisocyanate as above with an active hydrogen-containing component, especially the polyhydroxyl-containing materials or polyols described below. In some embodiments, the polyisocyanate is employed in proportions of about 30 percent to about 200 percent stoichiometric excess, the stoichiometry being based upon equivalents of isocyanate group per equivalent of hydroxyl in the polyol. The amount of polyisocyanate employed will vary slightly depending upon the nature of the polyurethane being prepared.

The active hydrogen-containing component can comprise polyether polyols and polyester polyols. Suitable polyester polyols are inclusive of polycondensation products of polyols with dicarboxylic acids or ester-forming derivatives thereof (such as anhydrides, esters and halides), polylactone polyols obtainable by ring-opening polymerization of lactones in the presence of polyols, polycarbonate polyols obtainable by reaction of carbonate diesters with polyols, and castor oil polyols. Suitable dicarboxylic acids and derivatives of dicarboxylic acids which are useful for producing polycondensation polyester polyols are aliphatic or cycloaliphatic dicarboxylic acids such as glutaric, adipic, sebacic, fumaric and maleic acids; dimeric acids; aromatic dicarboxylic acids such as, but not limited to phthalic, isophthalic and terephthalic acids; tribasic or higher functional polycarboxylic acids such as pyromellitic acid; as well as anhydrides and second alkyl esters, such as, but not limited to maleic anhydride, phthalic anhydride and dimethyl terephthalate.

Additional active hydrogen-containing components are the polymers of cyclic esters. Suitable cyclic ester monomers include, but are not limited to δ-valerolactone, ε-caprolactone, zeta-enantholactone, the monoalkyl-valerolactones, e.g., the monomethyl-, monoethyl-, and monohexyl-valerolactones. Suitable polyester polyols include caprolactone based polyester polyols, aromatic polyester polyols, ethylene glycol adipate based polyols, and mixtures comprising any one of the foregoing polyester polyols. Exemplary polyester polyols are polyester polyols made from ε-caprolactones, adipic acid, phthalic anhydride, terephthalic acid, or dimethyl esters of terephthalic acid.

The polyether polyols are obtained by the chemical addition of alkylene oxides, such as ethylene oxide, propylene oxide and mixtures thereof, to water or polyhydric organic components, such as ethylene glycol, propylene glycol, trimethylene glycol, 1,2-butylene glycol, 1,3-butanediol, 1,4-butanediol, 1,5-pentanediol, 1,2-hexylene glycol, 1,10-decanediol, 1,2-cyclohexanediol, 2-butene-1,4-diol, 3-cyclohexene-1,1-dimethanol, 4-methyl-3-cyclohexene-1,1-dimethanol, 3-methylene-1,5-pentanediol, diethylene glycol, (2-hydroxyethoxy)-1-propanol, 4-(2-hydroxyethoxy)-1-butanol, 5-(2-hydroxypropoxy)-1-pentanol, 1-(2-hydroxymethoxy)-2-hexanol, 1-(2-hydroxypropoxy)-2-octanol, 3-allyloxy-1,5-pentanediol, 2-allyloxymethyl-2-methyl-1,3-propanediol, [4,4-pentyloxy)-methyl]-1,3-propanediol, 3-(o-propenylphenoxy)-1,2-propanediol, 2,2′-diisopropylidenebis(p-phenyleneoxy)diethanol, glycerol, 1,2,6-hexanetriol, 1,1,1-trimethylolethane, 1,1,1-trimethylolpropane, 3-(2-hydroxyethoxy)-1,2-propanediol, 3-(2-hydroxypropoxy)-1,2-propanediol, 2,4-dimethyl-2-(2-hydroxyethoxy)-methylpentanediol-1,5; 1,1,1-tris[2-hydroxyethoxy) methyl]-ethane, 1,1,1-tris[2-hydroxypropoxy)-methyl] propane, diethylene glycol, dipropylene glycol, pentaerythritol, sorbitol, sucrose, lactose, alpha-methylglucoside, alpha-hydroxyalkylglucoside, novolac resins, phosphoric acid, benzenephosphoric acid, polyphosphoric acids such as tripolyphosphoric acid and tetrapolyphosphoric acid, ternary condensation products, and the like. The alkylene oxides employed in producing polyoxyalkylene polyols normally have from 2 to 4 carbon atoms. Exemplary alkylene oxides are propylene oxide and mixtures of propylene oxide with ethylene oxide. The polyols listed above can be used per se as the active hydrogen component.

A suitable class of polyether polyols is represented generally by the following formula

R[(OCₙH₂ₙ)_{z}OH]ₐ

wherein R is hydrogen or a polyvalent hydrocarbon radical; a is an integer (i.e., 1 or 2 to 6 to 8) equal to the valence of R, n in each occurrence is an integer from 2 to 4 inclusive (specifically 3) and z in each occurrence is an integer having a value of from 2 to about 200, specifically from 15 to about 100. In some embodiments, the polyether polyol comprises a mixture of one or more of dipropylene glycol, 1,4-butanediol, 2-methyl-1,3-propanediol, or the like, or combinations comprising at least one of the foregoing polyether polyols.

Other types of active hydrogen-containing materials that can be used are polymer polyol compositions obtained by polymerizing ethylenically unsaturated monomers in a polyol. Suitable monomers for producing such compositions include acrylonitrile, vinyl chloride, styrene, butadiene, vinylidene chloride, and other ethylenically unsaturated monomers. The polymer polyol compositions comprise greater than or equal to about 1, specifically greater than or equal to about 5, and more specifically greater than or equal to about 10 wt % monomer polymerized in the polyol where the weight percent is based on the total amount of polyol. In some embodiments, the polymer polyol compositions comprise less than or equal to about 70, specifically less than or equal to about 50, more specifically less than or equal to about 40 wt % monomer polymerized in the polyol. Such compositions are conveniently prepared by polymerizing the monomers in the selected polyol at a temperature of 40° C. to 150° C. in the presence of a free radical polymerization catalyst such as peroxides, persulfates, percarbonate, perborates, and azo compounds.

The active hydrogen-containing component can also contain polyhydroxyl-containing compounds, such as hydroxyl-terminated polyhydrocarbons, hydroxyl-terminated polyformals, fatty acid triglycerides, hydroxyl-terminated polyesters, hydroxymethyl-terminated perfluoromethylenes, hydroxyl-terminated polyalkylene ether glycols hydroxyl-terminated polyalkylenearylene ether glycols, and hydroxyl-terminated polyalkylene ether triols.

The polyols can have hydroxyl numbers that vary over a wide range. In general, the hydroxyl numbers of the polyols, including other cross-linking additives, if employed, are present in an amount of about 28 to about 1000, and higher, specifically about 100 to about 800. The hydroxyl number is defined as the number of milligrams of potassium hydroxide used for the complete neutralization of the hydrolysis product of the fully acetylated derivative prepared from 1 gram of polyol or mixtures of polyols with or without other cross-linking additives. The hydroxyl number can also be defined by the equation:

$$OH = \frac{56.1 \times 1000 \times f}{M . W .}$$

wherein OH is the hydroxyl number of the polyol, f is the average functionality, that is the average number of hydroxyl groups per molecule of polyol, and M.W. is the average molecular weight of the polyol.

Where used, a large number of blowing agents or a mixture of blowing agents are suitable, particularly water. The water reacts with the isocyanate component to yield CO₂ gas, which provides the additional blowing necessary. In some embodiments when water is used as the blowing agent, the curing reaction is controlled by selectively employing catalysts. In some embodiments, compounds that decompose to liberate gases (e.g., azo compounds) can also be used.

Especially suitable blowing agents are physical blowing agents comprising hydrogen atom-containing components, which can be used alone or as mixtures with each other or with another type of blowing agent such as water or azo compounds. These blowing agents can be selected from a broad range of materials, including hydrocarbons, ethers, esters and partially halogenated hydrocarbons, ethers and esters, and the like. Suitable physical blowing agents have a boiling point between about −50° C. and about 100° C., and specifically between about −50° C. and about 50° C. Among the usable hydrogen-containing blowing agents are the HCFC's (halo chlorofluorocarbons) such as 1,1-dichloro-1-fluoroethane, 1,1-dichloro-2,2,2-trifluoro-ethane, monochlorodifluoromethane, and 1-chloro-1,1-difluoroethane; the HFCs (halo fluorocarbons) such as 1,1,1,3,3,3-hexafluoropropane, 2,2,4,4-tetrafluorobutane, 1,1,1,3,3,3-hexafluoro-2-methylpropane, 1,1,1,3,3-pentafluoropropane, 1,1,1,2,2-pentafluoropropane, 1,1,1,2,3-pentafluoropropane, 1,1,2,3,3-pentafluoropropane, 1,1,2,2,3-pentafluoropropane, 1,1,1,3,3,4-hexafluorobutane, 1,1,1,3,3-pentafluorobutane, 1,1,1,4,4,4-hexafluorobutane, 1,1,1,4,4-pentafluorobutane, 1,1,2,2,3,3-hexafluoropropane, 1,1,1,2,3,3-hexafluoropropane, 1,1-difluoroethane, 1,1,1,2-tetrafluoroethane, and pentafluoroethane; the HFE's (halo fluoroethers) such as methyl-1,1,1-trifluoroethylether and difluoromethyl-1,1,1-trifluoroethylether; and the hydrocarbons such as n-pentane, isopentane, and cyclopentane.

When used, the blowing agents including water generally comprise greater than or equal to 1, specifically greater than or equal to 5 weight percent (wt %) of the polyurethane liquid phase composition. In some embodiments, the blowing agent is present in an amount of less than or equal to about 30, specifically less than or equal to 20 wt % of the polyurethane liquid phase composition. When a blowing agent has a boiling point at or below ambient temperature, it is maintained under pressure until mixed with the other components.

Suitable catalysts used to catalyze the reaction of the isocyanate component with the active hydrogen-containing component include organic and inorganic acid salts of, and organometallic derivatives of bismuth, lead, tin, iron, antimony, uranium, cadmium, cobalt, thorium, aluminum, mercury, zinc, nickel, cerium, molybdenum, vanadium, copper, manganese, and zirconium, as well as phosphines and tertiary organic amines. Examples of such catalysts are dibutyltin dilaurate, dibutyltin diacetate, stannous octoate, lead octoate, cobalt naphthenate, triethylamine, triethylenediamine, N,N,N′,N′-tetramethylethylenediamine, 1,1,3,3-tetramethylguanidine, N,N,N′N′-tetramethyl-1,3-butanediamine, N,N-dimethylethanolamine, N,N-diethylethanolamine, 1,3,5-tris (N,N-dimethylaminopropyl)-s-hexahydrotriazine, o- and p-(dimethylaminomethyl) phenols, 2,4,6-tris(dimethylaminomethyl) phenol, N,N-dimethylcyclohexylamine, pentamethyldiethylenetriamine, 1,4-diazobicyclo [2.2.2] octane, N-hydroxyl-alkyl quaternary ammonium carboxylates and tetramethylammonium formate, tetramethylammonium acetate, tetramethylammonium 2-ethylhexanoate and the like, as well as compositions comprising any one of the foregoing catalysts.

In an embodiment, the catalyst comprises a metal acetyl acetonate. Suitable metal acetyl acetonates include metal acetyl acetonates based on metals such as aluminum, barium, cadmium, calcium, cerium (III), chromium (III), cobalt (II), cobalt (III), copper (II), indium, iron (II), lanthanum, lead (II), manganese (II), manganese (III), neodymium, nickel (II), palladium (II), potassium, samarium, sodium, terbium, titanium, vanadium, yttrium, zinc and zirconium. An exemplary catalyst is bis(2,4-pentanedionate) nickel (II) (also known as nickel acetylacetonate or diacetylacetonate nickel) and derivatives thereof such as diacetonitrilediacetylacetonato nickel, diphenylnitrilediacetylacetonato nickel, bis(triphenylphosphine)diacetyl acetylacetonato nickel, and the like. Ferric acetylacetonate (FeAA) is also a suitable catalyst, due to its relative stability, good catalytic activity, and lack of toxicity. In some embodiments, the metal acetylacetonate is conveniently added by predissolution in a suitable solvent such as dipropylene glycol or other hydroxyl containing components which will then participate in the reaction and become part of the final product.

In some methods of producing the polyurethane foams, the components for producing the foams, i.e., the isocyanate component, the active hydrogen-containing component, surfactant, catalyst, optional blowing agents, and other additives are first mixed together then subjected to mechanical frothing with air. Alternatively, the components can be added sequentially to the liquid phase during the mechanical frothing process. The gas phase of the froths is most specifically air because of its cheapness and ready availability. However, if desired, other gases can be used which are gaseous at ambient conditions and which are substantially inert or non-reactive with any component of the liquid phase. Such other gases include, for example, nitrogen, carbon dioxide, and fluorocarbons that are normally gaseous at ambient temperatures. The inert gas is incorporated into the liquid phase by mechanical beating of the liquid phase in high shear equipment such as in a Hobart mixer or an Oakes mixer. The gas can be introduced under pressure as in the usual operation of an Oakes mixer or it can be drawn in from the overlying atmosphere by the beating or whipping action as in a Hobart mixer. The mechanical beating operation specifically is conducted at pressures not greater than 7 to 14 kg/cm² (100 to 200 pounds per square inch (psi)). Readily available mixing equipment can be used and no special equipment is generally necessary. The amount of inert gas beaten into the liquid phase is controlled by gas flow metering equipment to produce a froth of the desired density. The mechanical beating is conducted over a period of a few seconds in an Oakes mixer, or about 3 to about 30 minutes in a Hobart mixer, or however long it takes to obtain the desired froth density in the mixing equipment employed. The froth as it emerges from the mechanical beating operation is substantially chemically stable and is structurally stable but easily workable at ambient temperatures, e.g., about 10° C. to about 40° C.

Silicone foams comprising a polysiloxane polymer can also be used as the polymer foam in the present method of preparing a polymer foam composite. A wide variety of thermosetting or otherwise curable silicone compositions can be used.

In some embodiments, the silicone foams are produced as a result of the reaction between water and hydride groups in a polysiloxane polymer precursor composition with the consequent liberation of hydrogen gas. This reaction is generally catalyzed by a noble metal, specifically a platinum catalyst. In some embodiments, the polysiloxane polymer has a viscosity of about 100 to 1,000,000 poise at 25° C. and has chain substituents selected from the group consisting of hydride, methyl, ethyl, propyl, vinyl, phenyl, and trifluoropropyl. The end groups on the polysiloxane polymer can be hydride, hydroxyl, vinyl, vinyl diorganosiloxy, alkoxy, acyloxy, allyl, oxime, aminoxy, isopropenoxy, epoxy, mercapto groups, or other known, reactive end groups. Suitable silicone foams can also be produced by using several polysiloxane polymers, each having different molecular weights (e.g., bimodal or trimodal molecular weight distributions) as long as the viscosity of the combination lies within the above specified values. It is also possible to have several polysiloxane base polymers with different functional or reactive groups in order to produce the desired foam. In some embodiments, the polysiloxane polymer comprises about 0.2 moles of hydride (Si—H) groups per mole of water.

Depending upon the chemistry of the polysiloxane polymers used, a catalyst, generally platinum or a platinum-containing catalyst, can be used to catalyze the blowing and the curing reaction. The catalyst can be deposited onto an inert carrier, such as silica gel, alumina, or carbon black, or on a removable layer as disclosed herein. In some embodiments, an unsupported catalyst selected from among chloroplatinic acid, its hexahydrate form, its alkali metal salts, and its complexes with organic derivatives is used. Exemplary catalysts are the reaction products of chloroplatinic acid with vinylpolysiloxanes such as 1,3-divinyltetramethyldisiloxane, which are treated or otherwise with an alkaline agent to partly or completely remove the chlorine atoms; the reaction products of chloroplatinic acid with alcohols, ethers, and aldehydes; and platinum chelates and platinous chloride complexes with phosphines, phosphine oxides, and with olefins such as ethylene, propylene, and styrene. It can also be desirable, depending upon the chemistry of the polysiloxane polymers to use other catalysts such as dibutyl tin dilaurate in lieu of platinum based catalysts.

Various platinum catalyst inhibitors can also be used to control the kinetics of the blowing and curing reactions in order to control the porosity and density of the silicone foams. Examples of such inhibitors include polymethylvinylsiloxane cyclic compounds and acetylenic alcohols. These inhibitors should not interfere with the foaming and curing in such a manner that destroys the foam.

Physical or chemical blowing agents can be used to produce the silicone foam, including the physical and chemical blowing agents listed above for polyurethanes. Other examples of chemical blowing agents include benzyl alcohol, methanol, ethanol, isopropyl alcohol, butanediol, and silanols. In some embodiments, a combination of methods of blowing is used to obtain foams having desirable characteristics. For example, a physical blowing agent such as a chlorofluorocarbon can be added as a secondary blowing agent to a reactive mixture wherein the primary mode of blowing is the hydrogen released as the result of the reaction between water and hydride substituents on the polysiloxane.

Alternatively, a soft silicone composition can be formed by the reaction of a precursor composition comprising a liquid silicone composition comprising a polysiloxane having at least two alkenyl groups per molecule; a polysiloxane having at least two silicon-bonded hydrogen atoms in a quantity effective to cure the composition; a catalyst; and optionally a reactive or non-reactive polysiloxane fluid having a viscosity of about 100 to about 1000 centipoise. Suitable reactive silicone compositions are low durometer, 1:1 liquid silicone rubber (LSR) or liquid injection molded (LIM) compositions. Because of their low inherent viscosity, the use of the low durometer LSR or LIM results in formation of a soft foam.

In some embodiments, the polysiloxane fluid remains within the cured silicone and is not extracted or removed. The reactive silicone fluid thus becomes part of the polymer matrix, leading to low outgassing and little or no migration to the surface during use. In some embodiments, the boiling point of the non-reactive silicone fluid is high enough such that when it is dispersed in the polymer matrix, it does not evaporate during or after cure, and does not migrate to the surface or outgas.

In some embodiments, LSR or LIM systems are provided as two-part formulations suitable for mixing in ratios of about 1:1 by volume. The “A” part of the formulation comprises one or more polysiloxanes having two or more alkenyl groups and has an extrusion rate of less than about 500 grams per minute (g/minute). Suitable alkenyl groups are exemplified by vinyl, allyl, butenyl, pentenyl, hexenyl, and heptenyl, with vinyl being particularly suitable. The alkenyl group can be bonded at the molecular chain terminals, in pendant positions on the molecular chain, or both. Other silicon-bonded organic groups in the polysiloxane having two or more alkenyl groups are exemplified by substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Exemplary substituents are methyl and phenyl groups.

The alkenyl-containing polysiloxane can have straight chain, partially branched straight chain, branched-chain, or network molecule structure, or can be a mixture of two or more selections from polysiloxanes with the exemplified molecular structures. The alkenyl-containing polysiloxane is exemplified by trimethylsiloxy-endblocked dimethylsiloxane-methylvinylsiloxane copolymers, trimethylsiloxy-endblocked methylvinylsiloxane-methylphenylsiloxane copolymers, trimethylsiloxy-end blocked dimethylsiloxane-methylvinylsiloxane-methylphenylsiloxane copolymers, dimethylvinylsiloxy-endblocked dimethylpolysiloxanes, dimethylvinylsiloxy-endblocked methylvinylpolysiloxanes, dimethylvinylsiloxy-endblocked methylvinylphenylsiloxanes, dimethylvinylsiloxy-endblocked dimethylvinylsiloxane-methylvinylsiloxane copolymers, dimethylvinylsiloxy-endblocked dimethylsiloxane-methylphenylsiloxane copolymers, dimethylvinylsiloxy-endblocked dimethylsiloxane-diphenylsiloxane copolymers, polysiloxane comprising R₃SiO_{1/2} and SiO_{4/2} units, polysiloxane comprising RSiO_{3/2} units, polysiloxane comprising the R₂SiO_{2/2} and RSiO_{3/2} units, polysiloxane comprising the R₂SiO_{2/2}, RSiO_{3/2} and SiO_{4/2} units, and a mixture of two or more of the preceding polysiloxanes. R represents substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl, with the proviso that at least 2 of the R groups per molecule are alkenyl.

The “B” component of the LSR or LIM system comprises one or more polysiloxanes that contain at least two silicon-bonded hydrogen atoms per molecule and has an extrusion rate of less than about 500 g/minute. The hydrogen can be bonded at the molecular chain terminals, in pendant positions on the molecular chain, or both. Other silicon-bonded groups are organic groups exemplified by non-alkenyl, substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Exemplary substituents are methyl and phenyl groups.

The hydrogen-containing polysiloxane component can have straight-chain, partially branched straight-chain, branched-chain, cyclic, network molecular structure, or can be a mixture of two or more selections from polysiloxanes with the exemplified molecular structures. The hydrogen-containing polysiloxane is exemplified by trimethylsiloxy-endblocked methylhydrogenpolysiloxanes, trimethylsiloxy-endblocked dimethylsiloxane-methylhydrogensiloxane copolymers, trimethylsiloxy-endblocked methylhydrogensiloxane-methylphenylsiloxane copolymers, trimethylsiloxy-endblocked dimethylsiloxane-methylhydrogensiloxane-methylphenylsiloxane copolymers, dimethylhydrogensiloxy-endblocked dimethylpolysiloxanes, dimethylhydrogensiloxy-endblocked methylhydrogenpolysiloxanes, dimethylhydrogensiloxy-endblocked dimethylsiloxanes-methylhydrogensiloxane copolymers, dimethylhydrogensiloxy-endblocked dimethylsiloxane-methylphenylsiloxane copolymers, and dimethylhydrogensiloxy-endblocked methylphenylpolysiloxanes.

The hydrogen-containing polysiloxane component is added in an amount sufficient to cure the composition, specifically in a quantity of about 0.5 to about 10 silicon-bonded hydrogen atoms per alkenyl group in the alkenyl-containing polysiloxane.

The silicone composition further comprises, generally as part of Component “A,” a catalyst such as platinum to accelerate the cure. Platinum and platinum compounds known as hydrosilylation-reaction catalysts can be used, for example platinum black, platinum-on-alumina powder, platinum-on-silica powder, platinum-on-carbon powder, chloroplatinic acid, alcohol solutions of chloroplatinic acid platinum-olefin complexes, platinum-alkenylsiloxane complexes and the catalysts afforded by the microparticulation of the dispersion of a platinum addition-reaction catalyst, as described above, in a thermoplastic resin such as methyl methacrylate, polycarbonate, polystyrene, silicone, and the like. Mixtures of catalysts can also be used. A quantity of catalyst effective to cure the present composition is generally from 0.1 to 1,000 parts per million (by weight) of platinum metal based on the combined amounts of alkenyl and hydrogen components.

The composition optionally further comprises one or more polysiloxane fluids having a viscosity of less than or equal to about 1000 centipoise, specifically less than or equal to about 750 centipoise, more specifically less than or equal to about 600 centipoise, and most specifically less than or equal to about 500 centipoise. The polysiloxane fluids can also have a viscosity of greater than or equal to about 100 centipoises. The polysiloxane fluid component is added for the purpose of decreasing the viscosity of the composition, thereby allowing at least one of increased filler loading, enhanced filler wetting, and enhanced filler distribution, and resulting in cured compositions having lower resistance and resistivity values. Use of the polysiloxane fluid component can also reduce the dependence of the resistance value on temperature, and/or reduce the timewise variations in the resistance and resistivity values. Use of the polysiloxane fluid component obviates the need for an extra step during processing to remove the fluid, as well as possible outgassing and migration of diluent during use. The polysiloxane fluid should not inhibit the curing reaction, that is, the addition reaction, of the composition, but it may or may not participate in the curing reaction.

The non-reactive polysiloxane fluid has a boiling point of greater than about 500° F. (260° C.), and can be branched or straight-chained. The non-reactive polysiloxane fluid comprises silicon-bonded non-alkenyl organic groups exemplified by substituted and unsubstituted monovalent hydrocarbon groups, for example, alkyl groups such as methyl, ethyl, propyl, butyl, pentyl, and hexyl; aryl groups such as phenyl, tolyl, and xylyl; aralkyl groups such as benzyl and phenethyl; and halogenated alkyl groups such as 3-chloropropyl and 3,3,3-trifluoropropyl. Exemplary substituents are methyl and phenyl groups. Thus, the non-reactive polysiloxane fluid can comprise R₃SiO_{1/2} and SiO_{4/2} units, RSiO_{3/2} units, R₂SiO_{2/2} and RSiO_{3/2} units, or R₂SiO_{2/2}, RSiO_{3/2} and SiO_{4/2} units, wherein R represents substituted and unsubstituted monovalent hydrocarbon groups selected from the group consisting of alkyl, methyl, ethyl, propyl, butyl, pentyl, hexyl, aryl, phenyl, tolyl, xylyl, aralkyl, benzyl, phenethyl, halogenated alkyl, 3-chloropropyl, and 3,3,3-trifluoropropyl. Because the non-reactive polysiloxane is a fluid and has a significantly higher boiling point (greater than about 230° C. (500° F.)), it allows the incorporation of higher quantities of filler, but does not migrate or outgas. Examples of non-reactive polysiloxane fluids include DC 200 from Dow Corning Corporation.

Reactive polysiloxane fluids co-cure with the alkenyl-containing polysiloxane and the polysiloxane having at least two silicon-bonded hydrogen atoms, and therefore can themselves contain alkenyl groups or silicon-bonded hydrogen groups. Such compounds can have the same structures as described above in connection with the alkenyl-containing polysiloxane and the polysiloxane having at least two silicon-bonded hydrogen atoms, but in addition have a viscosity of less than or equal to about 1000 centipoise (cps), specifically less than or equal to about 750 cps, more specifically less than or equal to about 600 cps, and most specifically less than or equal to about 500 cps. In some embodiments, the reactive polysiloxane fluids have a boiling point greater than the curing temperature of the addition cure reaction.

The silicone foams can further optionally comprise a curable silicone gel formulation. Silicone gels are lightly cross-linked fluids or under-cured elastomers. They are unique in that they range from very soft and tacky to moderately soft and only slightly sticky to the touch. Use of a gel formulation decreases the viscosity of the composition. Suitable gel formulations can be either two-part curable formulations or one-part formulations. The components of the two-part curable gel formulations is similar to that described above for LSR systems (i.e., an organopolysiloxane having at least two alkenyl groups per molecule and an organopolysiloxane having at least two silicon-bonded hydrogen atoms per molecule). The molar ratio of the silicon-bonded hydrogen groups (Si—H) groups to the alkenyl groups is usually less than one, and can be varied to create a “under-cross linked” polymer with the looseness and softness of a cured gel. Specifically, the ratio of silicone-bonded hydrogen atoms to alkenyl groups is less than or equal to about 1.0, specifically less than or equal to about 0.75, more specifically less than or equal to about 0.6, and most specifically less than or equal to about 0.1. An example of a suitable two-part silicone gel formulation is SYLGARD 527 gel commercially available from the Dow Corning Corporation.

As described in further detail below, after forming the at least partially uncured polymer foam, the method further comprises contacting the formed polymer foam with a fibrous mat. The fibrous mat comprises a plurality of nonwoven fibers and is thus porous, i.e., comprises continuous voids that extend throughout the thickness of the mat.

The fibrous mat comprises a plurality of nonwoven fibers having an average diameter of 0.5 nanometer (nm) to 100 micrometer (um), or 10 nm to 50 um, or 100 nm to 10 um. In some embodiments, the nonwoven fibers are microfibers having an average diameter of 1 to 100 um, or 2 to 50 um, or 2 to 10 um. In some embodiments the nonwoven fibers are nanofibers having an average diameter of 0.5 to 900 nm, or 10 to 800, or 200 to 700 nm, or 1 to 100 nm, or 1 to 50 nm, or 10 to 50 nm.

The fibrous mat can have an average pore (void) diameter between fibers of 0.05 nm to 50 millimeters (mm), or 0.1 nm to 1 mm, or 1 nm to 500 um. In some embodiments the pores or voids can have an average diameter of 0.05 to 900 nm, or 0.1 to 800 nm, or 1 to 800 nm, or 10 to 700 nm, or 200 to 700 nm. In some embodiments, the pores or voids can have an average diameter of 1 um to 50 mm, or 5 um to 1000 um, or 10 to 800 um, or 10 to 500 um, or 100 to 900 um, or 200 to 700 um.

The fibrous mat can have a thickness of 1 um to 12 mm, or 10 um to 10 mm, or 100 um to 8 mm, or 100 um to 5 mm, or 100 um to 2 mm, or 100 um to 1 mm, or 100 to 500 um, or 100 to 250 um.

The nonwoven fibers can have cross-sections with various regular and irregular shapes including, but not limiting to circular, oval, square, rectangular, triangular, diamond, trapezoidal and polygonal. The number of sides of the polygonal cross-section can vary from 3 to 16. In some embodiments, the fibers preferably have a cross-section that is circular of substantially circular.

In an embodiment, the fibers comprise a thermoplastic polymer. Thermoplastic polymers that can be used include polymers that can be spun in to fibrous form such as conjugated polymers, biopolymers, water soluble polymers, and particle infused polymers. As used herein, the term “thermoplastic” refers to a material that is plastic or deformable, melts to a liquid when heated, and freezes to a brittle, glassy state when cooled sufficiently. Thermoplastics are typically high molecular weight polymers.

Examples of thermoplastic polymers that can be used include polyacetals (e.g., polyoxyethylene and polyoxymethylene), poly(C₁₋₆ alkyl)acrylates, polyacrylamides (including unsubstituted and mono-N— and di-N—(C₁₋₈ alkyl)acrylamides), polyacrylonitriles, polyamides (e.g., aliphatic polyamides, polyphthalamides, and polyaramides), polyamideimides, polyanhydrides, polyarylene ethers (e.g., polyphenylene ethers), polyarylene ether ketones (e.g., polyether ether ketones (PEEK) and polyether ketone ketones (PEKK), polyarylene ketones, polyarylene sulfides (e.g., polyphenylene sulfides (PPS)), polyarylene sulfones (e.g., polyethersulfones (PES), polyphenylene sulfones (PPS), and the like), polybenzothiazoles, polybenzoxazoles, polybenzimidazoles, polycarbonates (including homopolycarbonates and polycarbonate copolymers such as polycarbonate-siloxanes, polycarbonate-esters, and polycarbonate-ester-siloxanes), polyesters (e.g., polyethylene terephthalates, polybutylene terephthalates, polyarylates, and polyester copolymers such as polyester-ethers), polyetherimides (including copolymers such as polyetherimide-siloxane copolymers), polyimides (including copolymers such as polyimide-siloxane copolymers), poly(C₁₋₆ alkyl)methacrylates, polymethacrylamides (including unsubstituted and mono-N— and di-N—(C₁₋₈ alkyl)acrylamides), cyclic olefin polymers (including polynorbornenes and copolymers containing norbornenyl units, for example copolymers of a cyclic polymer such as norbornene and an acyclic olefin such as ethylene or propylene), polyolefins (e.g., polyethylenes, polypropylenes, and their halogenated derivatives (such as polytetrafluoroethylenes), and their copolymers, for example ethylene-alpha-olefin copolymers, polyoxadiazoles, polyoxymethylenes, polyphthalides, polysilazanes, polysiloxanes (silicones), polystyrenes (including copolymers such as acrylonitrile-butadiene-styrene (ABS) and methyl methacrylate-butadiene-styrene (MBS)), polysulfides, polysulfonamides, polysulfonates, polysulfones, polythioesters, polytriazines, polyureas, polyurethanes, vinyl polymers (including polyvinyl alcohols, polyvinyl esters, polyvinyl ethers, polyvinyl halides (e.g, polyvinyl fluoride), polyvinyl ketones, polyvinyl nitriles, polyvinyl thioethers, and polyvinylidene fluorides), or the like. A combination comprising at least one of the foregoing thermoplastic polymers can be used.

The thermoplastic polymers can have a weight average molecular weight (Mw) of about 1,000 to about 200,000 g/mol, or about 1,000 to about 10,000 g/mol. The thermoplastic polymers can have a melt flow of 1 g/10 minutes or higher, preferably 10 g/10 minutes or higher, up to 7,500 g/10 minutes, each determined according to ASTM D 1283 at 316° C. under a 5 kg load, and in another embodiment greater than about 50 g/10 minutes.

In some embodiments, some preferred polymers are those that exhibit an alpha transition temperature (T[alpha]) and include, for example: high density polyethylene, linear low density polyethylene, ethylene alpha-olefin copolymers, polypropylene, poly(vinylidene fluoride), poly(vinyl fluoride), poly(ethylene chlorotrifluoroethylene), polyoxymethylene, poly(ethylene oxide), ethylene-vinyl alcohol copolymer, and blends thereof.

Useful polyamides include, but are not limited to, synthetic linear polyamides, e.g., Nylon-6,6; Nylon-6,9; Nylon-6,10; Nylon-6,12; Nylon-11; Nylon-12 and Nylon-4,6, preferably Nylon 6 and Nylon 6,6, or a combination comprising at least one of the foregoing. Polyurethanes that can be used include aliphatic, cycloaliphatic, aromatic, and polycyclic polyurethanes, including those described above. Also useful are polyacrylates and polymethacrylates, which include, for example, polymers of acrylic acid, methyl acrylate, ethyl acrylate, acrylamide, methyacrylic acid, methyl methacrylate, n-butyl acrylate, and ethyl acrylate, to name a few. Other useful hydrocarbon polymers include polyesters, polycarbonates, polyketones, and polyureas.

Useful fluorine-containing thermoplastic polymers include crystalline or partially crystalline polymers such as copolymers of tetrafluoroethylene with one or more other monomers such as perfluoro(methyl vinyl)ether, hexafluoropropylene, perfluoro(propyl vinyl)ether; copolymers of tetrafluoroethylene with ethylenically unsaturated hydrocarbon monomers such as ethylene, or propylene.

Representative examples of polyolefins, as thermoplastic polymers are polyethylene, polypropylene, polybutylene, polymethylpentene (and co-polymers thereof), polynorbornene (and co-polymers thereof), poly 1-butene, poly(3-methylbutene), poly(4-methylpentene) and copolymers of ethylene with propylene, 1-butene, 1-hexene, 1-octene, 1-decene, 4-methyl-1-pentene and 1-octadecene. Representative combinations of polyolefins are combinations containing polyethylene and polypropylene, low-density polyethylene and high-density polyethylene, and polyethylene and olefin copolymers containing the copolymerizable monomers, some of which are described above, e.g., ethylene and acrylic acid copolymers; ethyl and methyl acrylate copolymers; ethylene and ethyl acrylate copolymers; ethylene and vinyl acetate copolymers-, ethylene, acrylic acid, and ethyl acrylate copolymers, and ethylene, acrylic acid, and vinyl acetate copolymers.

A thermoplastic elastomer (TPE) can be used, which is sometimes referred to as a thermoplastic rubber. TPEs can be copolymers or a physical mix of polymers including a rubber. Examples of TPEs that can be used include styrenic block copolymers (TPE-s), certain polyolefin blends (TPE-o), elastomeric alloys (TPE-v or TPV), thermoplastic polyurethanes (TPU), certain copolyesters, and certain polyamides.

In some embodiments, the thermoplastic polymer is a thermoplastic polyester elastomer (TPEE) comprising a poly(ether-ester) block copolymer. Poly(ether-ester) block copolymers consist essentially of “soft block” long-chain ester units of formula (1)

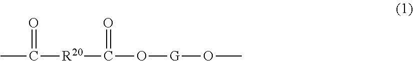

wherein G is a derived from a poly(C₁-C₄ alkylene oxide) glycol having a number-average molecular weight of 400 to 6000, and R²⁰ is derived from a C₄-C₂₄ aliphatic or aromatic dicarboxylic acid, preferably an aromatic dicarboxylic acid; and “hard block” short-chain ester units of formula (2)

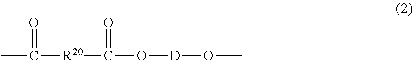

wherein D is a C₁-C₁₀ alkylene or cycloalkylene derived from the corresponding diol having a molecular weight of less than or equal to 300; and R²⁰ is derived from a C₈-C₂₄ alicyclic or aromatic dicarboxylic acid, preferably an aromatic dicarboxylic acid; with the proviso that the short-chain ester units constitute about 40% to about 90% by weight of the poly(ether-ester) block copolymer, and the long-chain ester units constitute about 10% to about 60% by weight of the poly(ether-ester) block copolymer.

In some embodiments, the hard segment of the thermoplastic polyester elastomer comprises a poly(alkylene terephthalate), a poly(alkylene isophthalate), 1,4-cyclohexane-dimethanol-1,4-cyclohexane dicarboxylate, or a combination comprising at least one of the foregoing. In some embodiments, the soft segment of the thermoplastic polyester elastomer comprises a polybutylene ether, a polypropylene ether, a polyethylene ether, a tetrahydrofuran, or a combination comprising at least one of the foregoing. In some embodiments, the soft segment of the thermoplastic polyester elastomer comprises a polybutylene ether.

A variety of poly(ether-ester) copolymers are commercially available, for example under the trademarks ARNITEL EM400 and ARNITEL EL630 poly(ether-ester) copolymers from DSM; HYTREL 3078, HYTREL 4056, HYTREL 4556, and HYTREL 6356 poly(ether-ester) copolymers from DuPont; and ECDEL 9966 poly(ether-ester) copolymer from Eastman Chemical. In all cases, the soft block is derived from tetrahydrofuran. In the HYTREL 4556, HYTREL 6356, ARNITEL EM400, and ARNITEL EL630 poly(ether-ester) copolymers, the hard block is based on poly(butylene terephthalate) (PBT). In the HYTREL 4056 poly(ester-ether) copolymer, the hard block contains isophthalate units in addition to terephthalate units. In the ECDEL 9966 poly(ether-ester) copolymer, the hard block is based on poly(1,4-cyclohexane-dimethanol-1,4-cyclohexane dicarboxylate) (PCCD) units.

In some embodiments, the thermoplastic polymer has a tensile elongation at break of greater than 100%, preferably greater than 150%, more preferably greater than 300%, measured according to ASTM D638. In some embodiments, the thermoplastic elastomer has a resiliency of greater than 50%, preferably at least 60%, more preferably at least 65%, measured according to ASTM D4964. In some embodiments, the thermoplastic polymer can have a melt flow index that is effective to allow melt blowing of the thermoplastic polymer to form the plurality of polymer fibers. For example, the thermoplastic polymer can have a melt flow index of greater than 5 grams per 10 minutes, measured according to ASTM D1238 or ISO 1133. In some embodiments, the nonwoven fibers comprise a thermoplastic polymer or combination of thermoplastic polymer effective to provide all the above described properties.

In some embodiments, the plurality of nonwoven fibers can exclude glass (i.e., no glass is intentionally added to the nonwoven fibers).

The thermoplastic polymers can include blends of homo- and copolymers, as well as blends of two or more homo- or copolymers. Miscibility and compatibility of polymers are determined by both thermodynamic and kinetic considerations. The particular thermoplastic polymer selected for use will depend upon the application or desired properties of the finished product. The thermoplastic polymer can be combined with conventional additives such as light stabilizers, fillers, staple fibers, antiblocking agents, antioxidants, and pigments.

In another embodiment, the fibers can include a metal, ceramic, or carbon-based material. Metals employed in fiber creation include, but are not limited to, bismuth, tin, zinc, silver, gold, nickel, aluminum, or combinations comprising at least one of the foregoing. The material used to form the fibers can be a ceramic such as alumina, titania, silica, zirconia, or combinations comprising at least one of the foregoing. The material used to form the fibers may be a composite of different metals (e.g., an alloy such as nitinol), a metal/ceramic composite, or a ceramic oxide (e.g., PVP with germanium/palladium/platinum). In an embodiment, the fibers include carbon.

The fibers of the fibrous mat can be prepared by any method that is generally known in the art. For example, fibers as discussed herein can be created using a solution spinning method or a melt spinning method. In both the melt and solution spinning methods, a material can be put into a fiber producing device which is spun at various speeds until fibers of appropriate dimensions are made. The material can be formed, for example, by melting a solute or can be a solution formed by dissolving a mixture of a solute and a solvent. Any solution or melt familiar to those of ordinary skill in the art can be employed. For solution spinning, a material can be designed to achieve a desired viscosity, or a surfactant can be added to improve flow, or a plasticizer can be added to soften a rigid fiber. In melt spinning, solid particles can comprise, for example, a metal or a polymer, wherein polymer additives can be combined with the latter.

In some embodiments, the fibers can be formed by centrifugal spinning. In a preferred embodiment, the fibrous mat includes a plurality of centrifugally spun fibers. In other embodiments still, the fibrous mat includes a plurality of centrifugally spun fibers formed from a thermoplastic polymer.

Centrifugal spinning can produce microfibers and nanofibers from a wide range of materials. As known to those skilled in the art, centrifugal spinning employs centrifugal force, rather than an electrostatic force, to spin fibers. In centrifugal spinning, either solutions or solid materials can be solution-spun or melt-spun into fibers. Key parameters to control the geometry and morphology of the fibers include rotational speed of the spinneret, collection system, and temperature. Orifices of the spinneret can have arbitrary geometric shapes to provide corresponding cross-sections of fibers. In a preferred embodiment, centrifugal spinning produces microfibers and/or nanofibers, preferably nanofibers. Centrifugal spinning is described, for example, in U.S. Pat. No. 3,388,194; U.S. Pat. No. 4,790,736; U.S. Pat. No. 7,786,034; U.S. Pat. No. 8,647,540; U.S. Pat. No. 8,647,541; U.S. Pat. No. 8,658,067; U.S. Pat. No. 8,709,309; and U.S. Pat. No. 8,721,319. Nanofiber mats are available via Forcespinning, a tradename of the FibeRio Technology Corporation (McAllen, Tex.).

In either the solution or melt centrifugal spinning method, as the material is ejected from the spinning fiber producing device, thin jets of the material are simultaneously stretched and dried or stretched and cooled in the surrounding environment. Interactions between the material and the environment at a high strain rate (due to stretching) lead to solidification of the material into fibers, which can be accompanied by evaporation of solvent. Non-limiting examples of solvents that can be used include oils, lipids, and organic solvents such as DMSO, toluene and alcohols. Water, such as de-ionized water, can also be used as a solvent. By manipulating the temperature and strain rate, the viscosity of the material can be controlled to manipulate the size and morphology of the fibers that are created. Non-limiting examples of fibers made using the melt centrifugal spinning method include polypropylene, acrylonitrile butadiene styrene (ABS) and nylon fibers. Non-limiting examples of fibers made using the solution centrifugal spinning method include polyethylene oxide (PEO) and beta-lactam fibers.

The creation of fibers can be done in batch modes or in continuous modes. In the latter case, material can fed continuously into the fiber producing device and the process can be continued over days (e.g., 1 to 7 days) and even weeks (e.g., 1 to 4 weeks).

In an embodiment, a method of creating fibers, such as microfibers and/or nanofibers, includes: heating a material; placing the material in a heated fiber producing device; and, after placing the heated material in the heated fiber producing device, rotating the fiber producing device to eject material to create nanofibers from the material. In some embodiments, the fibers can be microfibers and/or nanofibers. A heated fiber producing device is a structure that has a temperature that is greater than ambient temperature. “Heating a material” is defined as raising the temperature of that material to a temperature above ambient temperature. “Melting a material” is defined herein as raising the temperature of the material to a temperature greater than the melting point of the material, or, for polymeric materials, including thermoplastic polymers, raising the temperature above the glass transition temperature for the polymeric material. In alternate embodiments, the fiber producing device is not heated. Indeed, for any embodiment that employs a fiber producing device that can be heated, the fiber producing device can be used without heating. In some embodiments, the fiber producing device is heated but the material is not heated. The material becomes heated once placed in contact with the heated fiber producing device. In some embodiments, the material is heated and the fiber producing device is not heated. The fiber producing device becomes heated once it comes into contact with the heated material.

The spun fibers can then be collected. As used herein “collecting” of fibers refers to fibers coming to rest against a fiber collection device. After the fibers are collected, the fibers can be removed from a fiber collection device by a human or robot. A variety of methods and fiber (e.g., nanofiber) collection devices can be used to collect fibers. Regarding the fibers that are collected, in certain embodiments, at least some of the fibers that are collected are continuous, discontinuous, mat, woven, nonwoven, or a mixture of these configurations, preferably nonwoven.

In some embodiments, at least a portion of the fibers are crosslinked at a point of contact between the fibers. The crosslinking can occur during or after fiber manufacture. Crosslinking agents can be used to effect crosslinking between polymer chains, and can be included in the thermoplastic polymer composition. Exemplary crosslinking agents include carbodiimides, isocyanates, compounds have more than one ethylenic unsaturation, and the like. In some embodiments the crosslinking agent is a monomer or oligomer comprising two or more vinyl groups that can be crosslinked by photoinitiation, for example polyfunctional (C₁₋₂₀ alkyl) (meth)acrylate esters such as ethylene glycol dimethacrylate, diethylene glycol di(meth)acrylate, triethylene glycol di(meth)acrylate, tetraethylene glycol di(meth)acrylate, 1,3-butylene glycol di(meth)acrylate, 1,4-butylene glycol di(meth)acrylate, 1,4-butanediol di(meth)acrylate, 1,6-hexanediol di(meth)acrylate, neopentyl glycol di(meth)acrylate, ethoxylated bisphenol A di(meth)acrylate, trimethylol propane tri(meth)acrylate, pentaerythritol tetra(meth)acrylate, and the like, polymeric di(meth)acrylates such as polyethylene glycol di(meth)acrylate, and a combination comprising at least one of the foregoing. A crosslinking initiator, e.g., a photoinitiator, a crosslinking accelerator, or combination comprising at least one of the foregoing can be included in the thermoplastic composition.

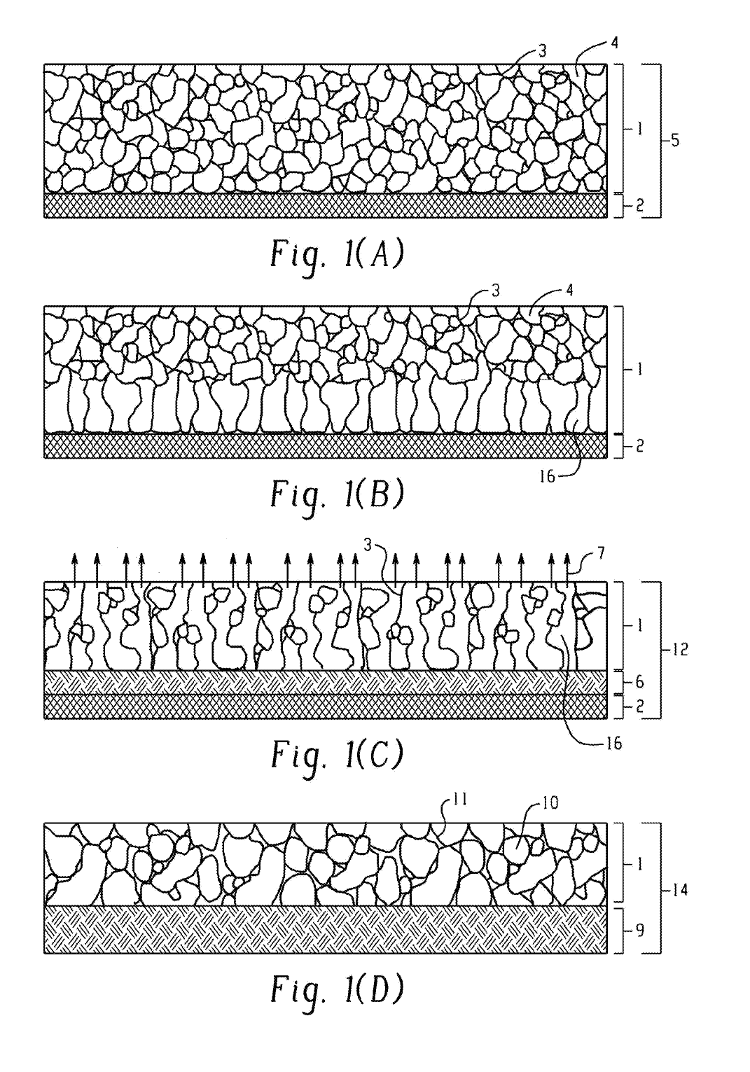

As stated above, and illustrated schematically in FIG. 1, after forming the at least partially uncured polymer foam, the method further comprises contacting the formed polymer foam with the fibrous mat comprising pore or voids. FIG. 1A shows a bilayer (5) comprising a polymer foam layer (1), which comprises a plurality of cells (4) having a first shape defined by a cell wall comprising the precursor polymer composition (3). Polymer foam layer (1) is disposed on and in intimate contact with a surface of a fibrous mat (2) having continuous voids therein spanning the thickness of the fibrous mat.

Foaming can be substantially complete before the contacting, or continue after the contacting. In some embodiments, the contacting comprises casting the formed polymer foam onto the fibrous mat to form a cast polymer foam layer. For example, after mechanical frothing, the polymer foam can be contacted with a fibrous mat, and the polymer foam can be spread to a layer of desired thickness by a doctoring blade or other suitable spreading device. A cover layer (not shown) can be contacted with the formed polymer foam layer on a side opposite the fibrous mat (2) to control the thickness or cell size of the polymer foam layer, or a patterned (e.g., embossed) cover layer (not shown) can be contacted with the polymer foam layer (1) to provide patterning on the cured foam layer.

Without being bound by theory, and as shown in FIG. 1B, it is believed that the cell structures of the formed polymer foam contacting fibrous mat (2) may be altered, for example the cells (16) may be collapsed or merged. As shown in FIG. 1C, the contacting is under conditions effective for at least a portion of the polymer from the polymer foam layer (1) to infiltrate into the voids of the fibrous mat (2) to form an intermixed polymer-fibrous mat zone (6). Again without being bound by theory, the merged or collapsed cells (16) in foam layer (1) may cause the evolution of air (7) up and into other cells and/or out of the foam. In this manner the fibrous mat absorbs a portion of the polymer foam. A portion of the thickness of the fibrous mat can be infiltrated as shown in FIG. 1C at (6) to provide a pre-composite (12), or the entire thickness of the mat can be infiltrated as shown in FIG. 1D to form an intermixed zone (9) of a pre-composite (14). The polymer present in zones (6) or (9) may be present in the form of a full or partial coating on the fibers or as pools within the pores formed by the fibers. Some residual cells may be present in the polymer.

Importantly, not all of the foam is infiltrated into the mat, such that a polymer foam layer (1) remains disposed on and in contact with the intermixed zone (6) or (9). The polymer precursor in the foam layer (1) and the intermixed zone (6) or (9) of pre-composite (12) or (14) is subsequently cured to form a cured polymer foam layer integrally bonded to an intermixed layer comprising the fibrous mat and a cured polymer that is the same as the polymer of the cured polymer foam layer. In some embodiments the cured polymer foam layer comprises cells having a second shape that is different from the first shape (4) defined by a cell wall comprising the at least partially uncured polymer. For example, the first shape can be substantially circular, and the second shape can be more elongated. In some embodiments, the cured polymer foam layer comprises cells having a second average diameter that is different from the first average diameter of the cells of the polymer foam layer.

In some embodiments, the cured polymer foam layer can be thinner than the polymer foam layer, thinner than the polymer foam layer of the pre-composite, or both. Alternatively, where the foam is only partially blown before being contacted with the fibrous mat, the cured polymer foam layer can be thicker than the polymer foam layer, or thicker than the polymer foam layer of the pre-composite, or both.

In a specific embodiment, a method of manufacturing a polyurethane foam composite comprises mechanically frothing a liquid composition comprising a polyisocyanate component, an active hydrogen-containing component reactive with the polyisocyanate component, a surfactant, and a catalyst; casting the formed polymer foam on the fibrous mat, specifically a nylon fibrous mat, to form a pre-composite comprising a polymer foam layer and an intermixed zone disposed on and in intimate contact with the polymer foam layer; and curing the pre-composite to form the polymer foam composite. It has been found by the inventors hereof that use of a polyurethane foam in combination with a nylon fibrous mat produces particularly good results, including lower foam density and improved mechanical robustness. Without being bound by theory, it is believed that the nylon affects movement of water in the foam, which results lowering the density of the cured foam, and the presence of the fibrous mat improves the mechanical properties of the foam.

Another aspect of the disclosure is a polymer foam composite formed by the method disclosed herein. A polymer foam composite comprises a cured polymer foam layer, and an intermixed layer integrally bonded to the cured polymer foam layer. As described above, the intermixed layer comprises a fibrous mat comprising a plurality of fibers having an average diameter of less than 1 mm, and a cured polymer that is the same as the polymer of the cured polymer foam. Specific embodiments include a cured polyurethane foam layer, and an intermixed layer integrally bonded to the cured polyurethane foam layer, wherein the intermixed layer comprises a nylon fibrous mat comprising a plurality of fibers having an average diameter of less than 100 um and the cured polyurethane. In some embodiments, the intermixed layer comprises the fibrous mat wherein at least a portion of the plurality of fibers are coated with the polymer. In some embodiments, at least a portion of the fibrous mat retains porosity.

The cured foam can have an open or closed a cellular structure and a density of 2 to 150 pounds per cubic foot (pcf) (80 to 2402 kilogram per cubic meter (kcm)), specifically 2 to 125 pcf (2002 kcm), more specifically to 100 pcf (1601 kcm), and still more specifically 2 to 60 pcf, or 2 to 20 pcf, or 5 to 60 pcf (160 to 961 kcm), or 5 to 20 pcf (160 to 641 kcm). Such foams have a void or cellular content of 20 to 99%, specifically greater than or equal to 30%, and more specifically greater than or equal to 50%, each based upon the total volume of the foam.

The average diameter of the cells of the polymer foam composite can be 10 to 1000 um, for example 20 to 500 or 20 to 200 um.

In a preferred embodiment, the polymer foam composite is thin, having a total thickness of 150 um to 12.5 mm, for example 200 um to 10 mm, or 250 um to 5 mm, or 300 um to 2 mm. In some embodiments, the polymer foam composite has a total thickness of 150 um to 12.5 mm, or 150 um to 10 mm, or 150 um to 5 mm, or 150 um to 3 mm, or 150 um to 2 mm, or 150 um to 1 mm. In some embodiments, the polymer foam composite has a thickness of 1 millimeter or less, or 10 micrometers to 750 micrometers, or 25 micrometers to 500 micrometers, or 50 to 500 micrometers. In some embodiments, the polymer foam composite has a total thickness of 0.25 mm or less, preferably 0.1 to 0.25 mm, more preferably 0.15 to 0.2 mm. Of this thickness, the relative thickness of each of the cured polymer foam layer, the intermixed layer, and the fibrous mat layer (if present) can vary widely, depending on the desired properties of the polymer composite. For example, the cured polymer foam layer can comprise 10 to 90% of the total thickness of the polymer composite, or 20 to 80% of the total thickness of the polymer composite, or 25 to 70% of the total thickness of the polymer composite.

In an embodiment, the polymer foam composite has improved mechanical properties compared to a polymer foam layer not including the intermixed layer. For example, the polymer foam composite can have a lower compressive force deflection than a polymer foam layer of the same density and thickness without the intermixed layer, preferably at least 5% lower, or at least 10% lower, or at least 20% lower, or at least 30% lower.

In some embodiments, the polymer foam composite can have a higher compression set resistance than a polymer foam layer of the same density and thickness without the intermixed layer, preferably at least 5% higher, or at least 10% higher, or at least 20% higher, or at least 30% higher.

In some embodiments, the polymer foam composite can have a higher tensile strength than a polymer foam layer of the same density and thickness without the intermixed layer, preferably at least 5% higher, or at least 10% higher, or at least 20% higher, or at least 30% higher. For example, the fiber mat enhanced polymer foam can have a tensile strength greater than or equal to 150 pounds per square inch (psi) (10.5 kg/cm²), for example 150 to 500 psi (10.5 to 35.1 kg/cm²), for example 200 to 400 psi (14 to 28 kg/cm²), for example 300 to 400 psi (21.1 to 28 kg/cm²).

In some embodiments, the polymer foam composite can have a higher tear strength than a polymer foam layer of the same density and thickness without the intermixed layer, preferably at least 5% higher, or at least 10% higher, or at least 20% higher, or at least 30% higher. For example, the polymer foam composite can have a tear strength greater than or equal to 15 psi (1.05 kg/cm²), for example 15 to 100 psi (1.05 to 7 kg/cm²), for example 20 to 75 psi (1.4 to 5.3 kg/cm²), for example 25 to 50 psi (1.75 to 3.5 kg/cm²).

In some embodiments, the polymer foam composite can have a higher impact reduction than a polymer foam layer of the same density and thickness without the intermixed layer, preferably at least 10% higher, or at least 15% higher, or at least 20% higher, or at least 30% higher. In some embodiments the impact reduction is 10% to 100%.

Another aspect of the disclosure is an article comprising the polymer foam composite. Articles which can benefit from the polymer foam composite are those that require an impact-absorbing component, particularly an impact-absorbing component that is required to be thin. Particular articles can include a component of an electronic device, a touch-based device, packing materials, backing material for printing devices, and the like. In some embodiments the polymer foam composite can be disposed on an internal component of an electronic device.

In some embodiments, the article can include one or more intervening layers between the polymer foam composite and an internal component of an electronic device, for example an adhesive layer. In some embodiments, the adhesive layer can be a pressure sensitive adhesive. As used herein, a pressure sensitive adhesive (PSA) is one that adheres with as little as finger pressure. The adhesives can optionally be further cured, for example by exposure to ultraviolet light in the presence of a photoinitiator, e.g., certain radiation-curable acrylatefsilicone PSAs. PSAs can include an adhesive elastomer as the primary base material and an optional tackifier. Examples of elastomers include a (C₁₋₆ alkyl) poly(meth)acrylate, including copolymers thereof with (meth)acrylic acid, polyvinyl alcohol, a polyvinyl acetate, a polyvinyl ether, a natural rubber such as a butyl rubber, a synthetic rubber such as a styrene block copolymer, a silicone, and a nitrile rubber. Examples of tackifiers include various terpene resins, aromatic resins, and hydrogenated hydrocarbon polymers. In some embodiments, the PSA includes a (C₁₋₆ alkyl) poly(meth)acrylate.

The polymer foam composites provided demonstrate improved physical properties, including compressive force deflection, tensile strength, tear strength, and impact absorption. The polymer foam composites further exhibit lower densities and thicknesses that conventional polymer foams prepared under the same casting conditions. Therefore, a substantial improvement in polymer foam composites is provided.

In a preferred embodiment, a method for the manufacture of a polymer foam composite comprises mechanically frothing a polyurethane foam precursor composition comprising an isocyanate component, an active hydrogen-containing component reactive with the isocyanate component, a surfactant, and a catalyst; casting the mechanically frothed foam onto a fibrous polyamide mat comprising a plurality of nonwoven fibers having an average diameter of 100 um or less, under conditions effective to infiltrate a portion of the frothed foam into the fibrous mat, to provide a pre-composite comprising a layer comprising the frothed polyurethane precursor composition, and an intermixed zone in contact with a side of the foam layer, the intermixed zone comprising the fibrous mat, and a portion of the polyurethane precursor composition disposed within the fibrous mat; and curing the pre-composite to form the polymer foam composite comprising a cured polyurethane foam layer; and an intermixed layer integrally bonded to the cured polyurethane foam layer, the intermixed layer comprising the fibrous mat, and a cured polyurethane the same as the polyurethane of the cured polyurethane foam layer.

A polymer foam composite formed by this method is included. Thus, in the preferred embodiment, a polymer foam composite comprises a cured polyurethane foam layer; and an intermixed layer integrally bonded to the cured polyurethane foam layer, the intermixed layer comprising a fibrous mat comprising a plurality of nylon fibers having an average diameter of 100 um or less, and a cured polyurethane the same as the polyurethane of the cured polyurethane foam layer. The polymer foam composite can have at least one of a lower compressive force deflection than a polymer foam layer of the same density and thickness without the intermixed layer, preferably at least 5% lower, or at least 10% lower, or at least 20% lower, or at least 30% lower; a higher compression set resistance than a polymer foam layer of the same density and thickness without the intermixed layer, preferably at least 5% higher, or at least 10% higher, or at least 20% higher, or at least 30% higher; a higher tensile strength than a polymer foam layer of the same density and thickness without the intermixed layer, preferably at least 5% higher, or at least 10% higher, or at least 20% higher, or at least 30% higher; a higher tear strength than a polymer foam layer of the same density and thickness without the intermixed layer, preferably at least 5% higher, or at least 10% higher, or at least 20% higher, or at least 30% higher; or a higher impact reduction than a polymer foam layer of the same density and thickness without the intermixed layer, preferably at least 10% higher, or at least 15% higher, or at least 20% higher, or at least 30% higher. The polymer foam composites can have a total thickness of 150 um to 12.5 mm, and a density of 2 to 60 pcf. Such composites are especially useful in an electronic device, for example a cellular telephone a smart telephone, a laptop computer, or a tablet computer.

### EXAMPLES

### Example 1 and Comparative Example 1

The following Examples demonstrate the process of preparing the polymer foam composite. A polyurethane foam was cast on a fibrous mat comprising nylon using a knife-over-roll process. The knife setting was 28 mils (0.1 mm) for the foams of the present Examples. The properties of the resulting polymer foam (Comparative Example 1) and corresponding polymer foam composite (Example 1) are summarized in Table 1 below.

As shown in Table 1, the foam of E1 was substantially thinner (0.016 inches; 0.4 mm) than the foam of CE1 (0.028 inches; 0.7 mm). In addition, the foam of E1 also exhibited improved mechanical properties including a reduced compressive force deflection (CFD) of 1.1 psi (0.08 kg/cm²), compared to 7.77 psi (0.55 kg/cm²) for CE1; an increased tensile strength of 366.9 psi (25.8 kg/cm²), compared to 143.2 psi (10.1 kg/cm²) of CE1; and an increased tear strength of 40.656 psi (2.85 kg/cm²), compared to 11.744 psi (0.82 kg/cm²) for CE1.

Thus, the process described herein can provide thin polymer foam composites having improved structural integrity.

TABLE 1

| | | | | Tensile | Tensile | Tear |
|---|---|---|---|---|---|---|
| | Density | Thickness | CFD | strength | elongation | strength |
| Example | (pcf) | (in) | (psi) | (psi) | (%) | (psi) |
| CE1 | 18.3 | 0.028 | 7.77 | 143.2 | 115 | 11.744 |
| E1 | — | 0.016 | 1.1 | 366.9 | 49 | 40.656 |

### Examples 2-3 and Comparative Examples 2-12

The impact performance of the polymer foam composite was determined relative to various foamed materials. To determine the impact performance, a ball drop test was used, where a steel ball having a weight of 4.3 grams was dropped onto the material from a height of 30.5 centimeters placed on a pressure sensor. Each impact test was performed in triplicate, and the results were averaged to obtain the reported value. The results are reported as a percent reduction in the measured impact force (“reduction percent”) by comparing the measured impact force for each material to a control drop that excluded the foam or polymer foam composite.

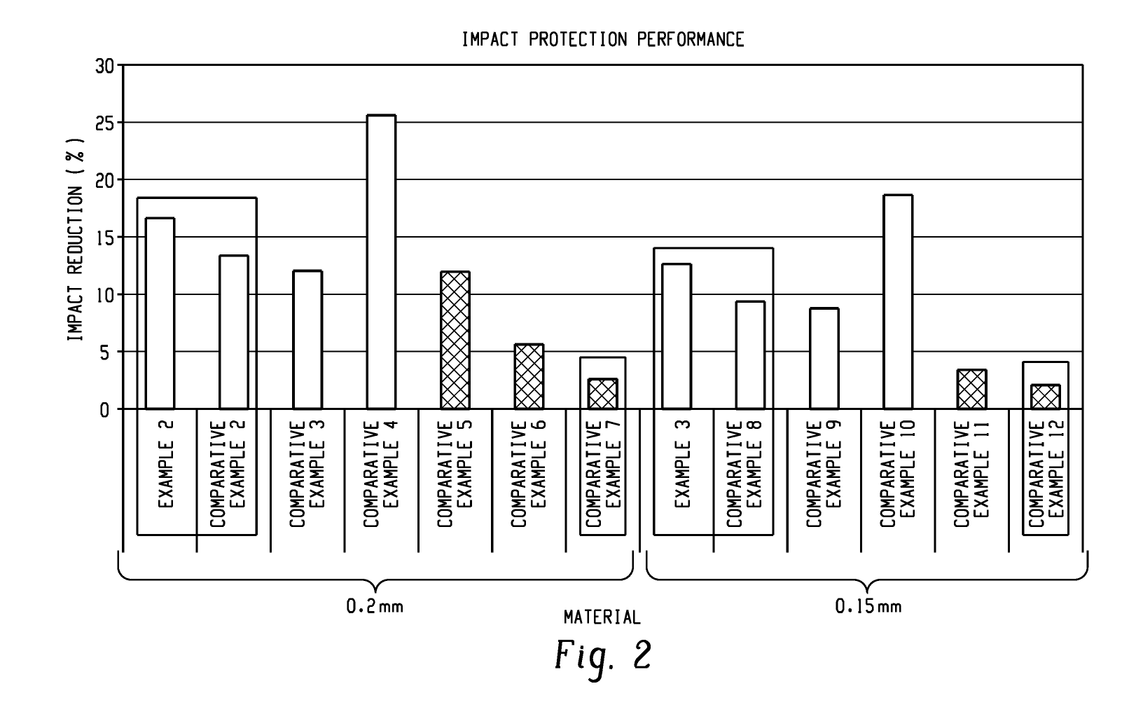

The polymer foam composites were prepared as described above, where a polyurethane foam was cast on a fibrous mat comprising polypropylene having a basis weight of 10 grams per square meter (gsm). The polymer foam composites were prepared having a thickness of 0.2 millimeters and 0.15 millimeters. For each thickness, the impact performance of various foams was also tested for comparison. A summary of the materials tested is provided in Table 2. The results of the impact testing for each example are shown in FIG. 2.

TABLE 2

| Example | Description |
|---|---|
| E2 | Polymer foam composite having a thickness of 0.2 millimeters, comprising a polyurethane |
| | foam cast on a fibrous mat comprising polypropylene having a basis weight of 10 gsm |
| E3 | Polymer foam composite having a thickness of 0.15 millimeters, comprising a polyurethane |
| | foam cast on a fibrous mat comprising polypropylene having a basis weight of 10 gsm |
| CE2 | Open-celled polyurethane foam with an incorporated polyethylene terephthalate (PET) support, |
| | having a density of 20 pounds per cubic foot (pcf) and a thickness of 0.2 millimeters obtained |
| | as PORON from Rogers Corp. |
| CE3 | Open-celled polyurethane foam having a density of 20 pcf and a thickness of 0.2 millimeters, |
| | obtained as PORON from Rogers Corp. |
| CE4 | Closed-cell polyolefin foam having a thickness of 0.2 millimeters, obtained as PORON |
| | SHOCKPAD from Rogers Corp. |
| CE5 | Foam having a thickness of 0.2 millimeters, obtained as DSF-200 from Polymercell |
| CE6 | Closed-cell polyolefin foam obtained as WL020 foam from Sekisui Chemical Co., having a |
| | thickness of 0.2 mm |
| CE7 | Closed-cell polypropylene foam obtained as Super Clean Foam SCF 400 available from Nitto |
| | having a thickness of 0.2 mm |
| CE8 | Open-celled polyurethane foam with an incorporated polyethylene terephthalate (PET) support, |
| | having a density of 20 pounds per cubic foot (pcf) and a thickness of 0.15 millimeters obtained |
| | as PORON from Rogers Corp. |
| CE9 | Open-celled polyurethane foam having a density of 20 pcf and a thickness of 0.15 millimeters, |
| | obtained as PORON from Rogers Corp. |
| CE10 | Closed-cell polyolefin foam having a thickness of 0.15 millimeters, obtained as PORON |
| | SHOCKPAD from Rogers Corp. |
| CE11 | Closed-cell polyolefin foam obtained as WL015 foam from Sekisui Chemical Co., having a |
| | thickness of 0.15 mm |
| CE12 | Closed-cell polypropylene foam obtained as Super Clean Foam SCF 400 available from Nitto |
| | having a thickness of 0.15 mm |

From FIG. 2 it can be seen that the polymer foam composites (E2 and E3) exhibited an increase in impact reduction compared to the foam alone (i.e., without the fibrous mat; CE2-CE12). The polymer foam composite having a thickness of 0.2 millimeters demonstrated an impact reduction of 15-20%, and the polymer foam composite having a thickness of 0.15 millimeters exhibited an impact reduction of 10-15%.

The polymer foam composites, articles, and methods described herein are further illustrated by the following embodiments, which are non-limiting.

### Embodiment 1

A method for the manufacture of a polymer foam composite, the method comprising forming a polymer foam that is at least partially uncured; contacting the formed polymer foam with a fibrous mat comprising a plurality of nonwoven fibers having an average diameter of 100 um or less, under conditions effective to infiltrate a portion of the polymer foam into the fibrous mat, to provide a pre-composite comprising a polymer foam layer, and an intermixed zone in contact with a side of the polymer foam layer, the intermixed zone comprising the fibrous mat, and a portion of the polymer of the polymer foam layer disposed within the fibrous mat; and curing the pre-composite to form the polymer foam composite comprising a cured polymer foam layer; and an intermixed layer integrally bonded to the cured polymer foam layer, the intermixed layer comprising the fibrous mat, and a cured polymer the same as the polymer of the cured polymer foam layer.

### Embodiment 2

The method of embodiment 1, wherein forming the polymer foam comprises mechanically frothing an uncured prepolymer composition.

### Embodiment 3

The method of embodiment 1 or 2, wherein the contacting comprises casting the formed polymer foam onto the fibrous mat to form a cast polymer foam layer, wherein the cast polymer foam layer is thicker than the polymer foam layer before curing.

### Embodiment 4

The method of any one or more of embodiments 1 to 3, wherein the polymer foam layer comprises cells having a first shape, and the cured polymer layer comprises cells having a second shape different from the first shape.

### Embodiment 5

The method of any one or more of embodiments 1 to 4, wherein the polymer foam layer comprises cells having a first average diameter, and the cured polymer layer comprises cells having a second diameter different from the first diameter.

### Embodiment 6

A polymer foam composite formed by the method of any one or more of embodiments 1 to 5.

### Embodiment 7

A polymer foam composite, comprising: a cured polymer foam layer; and an intermixed layer integrally bonded to the cured polymer foam layer, the intermixed layer comprising a fibrous mat comprising a plurality of fibers having an average diameter of 100 um or less, and a cured polymer the same as the polymer of the cured polymer foam layer.

### Embodiment 8

The polymer foam composite of embodiment 6 or 7, wherein at least a portion of the plurality of fibers are coated with the cured polymer.

### Embodiment 9

The polymer foam composite of any one or more of embodiments 6 to 8, wherein at least a portion of the fibrous mat retains porosity.

### Embodiment 10

The polymer foam composite of any one or more of embodiments 6 to 9, wherein the polymer foam composite has at least one of a lower compressive force deflection than a polymer foam layer of the same density and thickness without the intermixed layer, preferably at least 5% lower, or at least 10% lower, or at least 20% lower, or at least 30% lower; a higher compression set resistance than a polymer foam layer of the same density and thickness without the intermixed layer, preferably at least 5% higher, or at least 10% higher, or at least 20% higher, or at least 30% higher; a higher tensile strength than a polymer foam layer of the same density and thickness without the intermixed layer, preferably at least 5% higher, or at least 10% higher, or at least 20% higher, or at least 30% higher; a higher tear strength than a polymer foam layer of the same density and thickness without the intermixed layer, preferably at least 5% higher, or at least 10% higher, or at least 20% higher, or at least 30% higher; or a higher impact reduction than a polymer foam layer of the same density and thickness without the intermixed layer, preferably at least 10% higher, or at least 15% higher, or at least 20% higher, or at least 30% higher.

### Embodiment 11

The polymer foam composite of any one or more of embodiments 6 to 10, wherein the composite has a total thickness of 150 um to 12.5 mm, or 150 um to 10 mm, or 150 um to 5 mm, or 150 um to 3 mm, or 150 um to 2 mm, or 150 um to 1 mm.

### Embodiment 12

The polymer foam composite of any one or more of embodiments 6 to 10, wherein the composite has a thickness of 1 millimeter or less, or 10 micrometers to 750 micrometers, or 25 micrometers to 500 micrometers, or 50 to 500 micrometers.

### Embodiment 13

The polymer foam composite of any one or more of embodiments 6 to 12, wherein the polymer foam comprises a thermosetting polymer.

### Embodiment 14

The polymer foam composite of any one or more of embodiments 6 to 13, wherein the polymer foam comprises a polyurethane, epoxy, melamine, phenolic (e.g., phenol formaldehyde), urea-formaldehyde, vinyl ester, polyisocyanurate, acrylic, polyester, polyimide, silicone, or a combination comprising at least one of the foregoing, preferably a polyurethane, silicone, or a combination comprising at least one of the foregoing.

### Embodiment 15

The polymer foam composite of any one or more of embodiments 6 to 14, wherein the polymer foam comprises an additive comprising a reinforcing filler, flame retardant, dye, pigment (for example titanium dioxide and iron oxide), antioxidants, antiozonant, ultraviolet stabilizer, thermal stabilizer, conductive filler, catalyst for cure of the polymer, crosslinking agent, blowing agent, or a combination comprising at least one of the foregoing.

### Embodiment 16

The polymer foam composite of any one or more of embodiments 6 to 15, wherein the fibers comprise a thermoplastic polymer.

### Embodiment 17

The polymer foam composite of any one or more of embodiments 6 to 16, wherein the fibers comprise a thermoplastic elastomer, a polyacetal, poly(C₁₋₆ alkyl)acrylate, polyacrylamide, polyacrylonitrile, polyamide, polyamideimide, polyanhydride, polyarylene ether, polyarylene ether ketone, polyarylene ketone, polyarylene sulfide, polyarylene sulfone, polybenzothiazoles polybenzoxazole, polybenzimidazole, polycarbonate, polyester, polyetherimide, polyimide, poly(C₁₋₆ alkyl)methacrylate, polymethacrylamide, cyclic olefin polymer, polyolefin, polyoxadiazole, polyoxymethylene, polyphthalide, polysilazane, polysiloxane, polystyrene, polysulfide, polysulfonamide, polysulfonate, polythioester, polytriazine, polyurea, polyurethane, vinyl polymer, or a combination comprising at least one of the foregoing thermoplastic polymers; preferably a polyolefin, a thermoplastic elastomer, or a polyamide; more preferably a polypropylene, or a thermoplastic elastomer comprising a hard segment comprising a polyester block and a soft segment comprising a polyether block, or a nylon-6, or a nylon-6,6.

### Embodiment 18

The polymer foam composite of embodiment 16 or 17, wherein the thermoplastic polymer is a thermoplastic elastomer.

### Embodiment 19

The polymer foam composite of any one or more of embodiments 16 to 18, wherein the thermoplastic polymer has a melt flow index effective to allow melt blowing of the thermoplastic polymer, preferably wherein the thermoplastic polymer has a melt flow index of greater than 5 grams per 10 minutes, measured according to ASTM D1238 or ISO 1133.

### Embodiment 20

The polymer foam composite of any one or more of embodiments 18 to 19, wherein the thermoplastic elastomer comprises a hard segment comprising a polyester block and a soft segment comprising a polyether block.

### Embodiment 21

The polymer foam composite of embodiment 20, wherein the hard segment of the thermoplastic polyester elastomer comprises a poly(alkylene terephthalate), a poly(alkylene isophthalate), or a combination comprising at least one of the foregoing; and the soft segment of the thermoplastic polyester elastomer comprises a polyether comprising a polybutylene ether, a polypropylene ether, a polyethylene ether, or a combination comprising at least one of the foregoing, preferably, a polybutylene ether.

### Embodiment 22

The polymer foam composite of any one or more of embodiments 16 to 21, wherein the thermoplastic polymer comprises a polyolefin, preferably polypropylene.

### Embodiment 23

The polymer foam composite of any one or more of embodiments 6 to 22, wherein the plurality of nonwoven fibers further comprises a crosslinking agent.

### Embodiment 24

The polymer foam composite of any one or more of embodiments 6 to 23, wherein at least a portion of the plurality of fibers are crosslinked at a point of contact between the fibers.

### Embodiment 25

The polymer foam composite of embodiments 23 or 24, wherein the crosslinking occurs during or after fiber manufacture.

### Embodiment 26

The polymer foam composite of any one or more of embodiments 6 to 25, wherein the plurality of nonwoven fibers exclude glass.

### Embodiment 27

The polymer foam composite of any one or more of embodiments 6 to 26, wherein the fibrous mat has a thickness from 1 um to 12 mm, or 10 um to 10 mm, or 100 um to 8 mm, or 100 um to 5 mm, or 100 um to 2 mm, or 100 um to 1 mm, or 100 to 500 um, or 100 to 250 um.

### Embodiment 28

The polymer foam composite of any one or more of embodiments 6 to 27, wherein the plurality of fibers have an average diameter of 0.5 nm to 100 um, or 10 nm to 50 um, or 100 nm to 10 um; or an average diameter of 1 to 100 um, or 2 to 50 um, or 10 to 500 um, or 100 to 900 um, or 200 to 770 nm; or an average diameter of 0.5 to 900 nm, or 10 to 800 nm, or 200 to 700 nm, or 1 to 100 nm, or 10 to 50 nm.

### Embodiment 29

The polymer foam composite of any one or more of embodiments 6 to 28, wherein the fibrous mat has an average pore diameter between fibers of 0.05 nm 50 mm, or 0.1 nm to 1 mm, or 1 nm to 500 um.

### Embodiment 30

The polymer foam composite of any one or more of embodiments 6 to 29, wherein the fibers have a regular or irregular cross-section, preferably circular, oval, square, rectangular, triangular, diamond, trapezoidal, or polygonal, most preferably circular or substantially circular.

### Embodiment 31

An article comprising the polymer foam composite of any one or more of embodiments 6 to 30.

### Embodiment 32

The article of embodiment 31, wherein the article is an electronic device, for example a cellular telephone, a smart telephone, a laptop computer, or a tablet computer.

### Embodiment 33

A method for the manufacture of a polymer foam composite, comprising mechanically frothing a polyurethane foam precursor composition comprising an isocyanate component, an active hydrogen-containing component reactive with the isocyanate component, a surfactant, and a catalyst; casting the mechanically frothed foam onto a fibrous polyamide mat comprising a plurality of nonwoven fibers having an average diameter of 100 um or less, under conditions effective to infiltrate a portion of the frothed foam into the fibrous mat, to provide a pre-composite comprising a layer comprising the frothed polyurethane precursor composition, and an intermixed zone in contact with a side of the foam layer, the intermixed zone comprising the fibrous mat, and a portion of the polyurethane precursor composition disposed within the fibrous mat; and curing the pre-composite to form the polymer foam composite comprising a cured polyurethane foam layer; and an intermixed layer integrally bonded to the cured polyurethane foam layer, the intermixed layer comprising the fibrous mat, and a cured polyurethane the same as the polyurethane of the cured polyurethane foam layer.

### Embodiment 34

A polymer foam composite formed by the method of embodiment 33.

### Embodiment 35

A polymer foam composite, comprising: a cured polyurethane foam layer; and an intermixed layer integrally bonded to the cured polyurethane foam layer, the intermixed layer comprising a fibrous mat comprising a plurality of nylon fibers having an average diameter of 100 um or less, and a cured polyurethane the same as the polyurethane of the cured polyurethane foam layer.

### Embodiment 36

The polymer foam composite of any one or more of embodiments 34 to 35, wherein the polymer foam composite has at least one of: a lower compressive force deflection than a polymer foam layer of the same density and thickness without the intermixed layer, preferably at least 5% lower, or at least 10% lower, or at least 20% lower, or at least 30% lower; a higher compression set resistance than a polymer foam layer of the same density and thickness without the intermixed layer, preferably at least 5% higher, or at least 10% higher, or at least 20% higher, or at least 30% higher; a higher tensile strength than a polymer foam layer of the same density and thickness without the intermixed layer, preferably at least 5% higher, or at least 10% higher, or at least 20% higher, or at least 30% higher; a higher tear strength than a polymer foam layer of the same density and thickness without the intermixed layer, preferably at least 5% higher, or at least 10% higher, or at least 20% higher, or at least 30% higher; or a higher impact reduction than a polymer foam layer of the same density and thickness without the intermixed layer, preferably at least 10% higher, or at least 15% higher, or at least 20% higher, or at least 30% higher.

### Embodiment 37

The polymer foam composite of any one or more of embodiments 34 to 36, wherein the composite has a total thickness of 150 um to 12.5 mm.

### Embodiment 38

The polymer foam composite of any one or more of embodiments 34 to 37, wherein the composite has a total thickness of 0.25 mm or less, preferably 0.1 to 0.25 mm, more preferably 0.15 to 0.2 mm.

### Embodiment 39

The polymer foam composite of any one or more of embodiments 34 to 38, wherein the polyurethane foam layer has a density of 2 to 60 pcf.

### Embodiment 40

An article comprising the polymer foam composite of any one or more of embodiments 34 to 39.

### Embodiment 41

The article of embodiment 40, wherein the article is an electronic device, for example a cellular telephone, a smart telephone, a laptop computer, or a tablet computer.

In general, the methods, polymer foam composites, and articles can alternatively comprise, consist of, or consist essentially of, any appropriate components herein disclosed. The methods, polymer foam composites, and articles can additionally, or alternatively, be formulated so as to be devoid, or substantially free, of any components, materials, ingredients, adjuvants or species used in the prior art compositions or that are otherwise not necessary to the achievement of the function and/or objectives of the present invention.

All ranges disclosed herein are inclusive of the endpoints, and the endpoints are independently combinable with each other. “Combination” is inclusive of blends, mixtures, alloys, reaction products, and the like. The terms “a” and “an” and “the” herein do not denote a limitation of quantity, and are to be construed to cover both the singular and the plural, unless otherwise indicated herein or clearly contradicted by context. “Or” means “and/or.” Reference throughout the specification to “some embodiments”, “another embodiment”, “an embodiment,” and so forth, means that a particular element described in connection with the embodiment is included in at least some embodiments described herein, and may or may not be present in other embodiments. “Optional” or “optionally” means that the subsequently described event or circumstance can or cannot occur, and that the description includes instances where the event occurs and instances where it does not. Unless defined otherwise, technical and scientific terms used herein have the same meaning as is commonly understood by one of skill in the art to which this invention belongs. In addition, it is to be understood that the described elements may be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A method for the manufacture of a polymer foam composite, the method comprising
forming a polymer foam that is at least partially uncured;
contacting the formed polymer foam with a fibrous mat comprising a plurality of nonwoven fibers having an average diameter of 100 um or less, under conditions effective to infiltrate a portion of the polymer foam into the fibrous mat, to provide a pre-composite comprising
a polymer foam layer, and
an intermixed zone in contact with a side of the polymer foam layer, the intermixed zone comprising
the fibrous mat, and
a portion of the polymer of the polymer foam layer disposed within the fibrous mat; and
curing the pre-composite to form the polymer foam composite comprising a cured polymer foam layer; and
an intermixed layer integrally bonded to the cured polymer foam layer, the intermixed layer comprising
the fibrous mat, and
a cured polymer the same as the polymer of the cured polymer foam layer.

2. The method of claim 1, wherein forming the polymer foam comprises mechanically frothing an uncured prepolymer composition.

3. The method of claim 1, wherein the contacting comprises casting the formed polymer foam onto the fibrous mat to form a cast polymer foam layer, wherein the cast polymer foam layer is thicker than the polymer foam layer before curing.

4. The method of claim 1, wherein the polymer foam layer comprises cells having a first shape, and the cured polymer layer comprises cells having a second shape different from the first shape.

5. The method of claim 1, wherein the polymer foam layer comprises cells having a first average diameter, and the cured polymer layer comprises cells having a second diameter different from the first diameter.

6. The method of claim 1, wherein
forming polymer foam layer comprises mechanically frothing a polyurethane foam precursor composition comprising an isocyanate component, an active hydrogen-containing component reactive with the isocyanate component, a surfactant, and a catalyst;
contacting the formed polymer foam with the fibrous mat onto the fibrous mat to provide the pre-composite, wherein the fibrous mat is a fibrous polyamide mat, and the pre-composite comprises
the fibrous mat, and
a portion of the polyurethane precursor composition disposed within the fibrous mat; and
curing the pre-composite forms the polymer foam composite comprising
a cured polyurethane foam layer; and
an intermixed layer integrally bonded to the cured polyurethane foam layer, the intermixed layer comprising
the fibrous mat, and
a cured polyurethane the same as the polyurethane of the cured polyurethane foam layer.

7. A polymer foam composite formed by the method of claim 1.

8. A polymer foam composite, comprising:
a cured polymer foam layer; and
an intermixed layer integrally bonded to the cured polymer foam layer, the intermixed layer comprising
a fibrous mat comprising a plurality of fibers having an average diameter of 100 um or less, and
a cured polymer the same as the polymer of the cured polymer foam layer.

9. The polymer foam composite of claim 7, wherein at least a portion of the plurality of fibers are coated with the cured polymer.

10. The polymer foam composite of claim 7, wherein the fibrous mat has an average pore diameter between fibers of 0.05 nm 50 mm, and wherein at least a portion of the fibrous mat retains porosity.

11. The polymer foam composite of claim 7, wherein the polymer foam composite has at least one of
a lower compressive force deflection than a polymer foam layer of the same density and thickness without the intermixed layer;
a higher compression set resistance than a polymer foam layer of the same density and thickness without the intermixed layer;
a higher tensile strength than a polymer foam layer of the same density and thickness without the intermixed layer;
a higher tear strength than a polymer foam layer of the same density and thickness without the intermixed layer; or
a higher impact reduction than a polymer foam layer of the same density and thickness without the intermixed layer.

12. The polymer foam composite of claim 7, wherein the composite has a total thickness of
150 um to 12.5 mm; or
1 millimeter or less; or
0.25 millimeter or less.

13. The polymer foam composite of claim 7, wherein the polymer foam comprises a thermosetting polymer.

14. The polymer foam composite of claim 7, wherein the fibers comprise a thermoplastic polymer.

15. The polymer foam composite of claim 14, wherein the thermoplastic polymer has a melt flow index effective to allow melt blowing of the thermoplastic polymer.

16. The polymer foam composite of claim 7, wherein the plurality of nonwoven fibers further comprises a crosslinking agent.

17. The polymer foam composite of claim 7, wherein at least a portion of the plurality of fibers are crosslinked at a point of contact between the fibers.

18. The polymer foam composite of claim 7, wherein the plurality of nonwoven fibers exclude glass.

19. The polymer foam composite of claim 7, wherein the fibrous mat has a thickness from 1 um to 12 mm.

20. The polymer foam composite of claim 7, wherein the plurality of fibers have
an average diameter of 0.5 nm to 100 um; or
an average diameter of 1 to 100 um; or
an average diameter of 0.5 to 900 nm.

21. The polymer foam composite of claim 7, wherein the fibers have a regular or irregular cross-section.

22. The polymer foam composite of claim 7, wherein
the cured polymer foam layer is a cured polyurethane foam layer; and
the intermixed layer is integrally bonded to the cured polyurethane foam layer, the intermixed layer comprising
a fibrous mat comprising a plurality of nylon fibers having an average diameter of 100 um or less, and
a cured polyurethane the same as the polyurethane of the cured polyurethane foam layer.

23. An article comprising the polymer foam composite of claim 7.

24. The article of claim 23, wherein the article is an electronic device.
